(19) United States
(12) Patent Application Publication
(10) Pub. No.: US 2010/0311029 A1
(43) Pub. Date: Dec. 9, 2010

(54) MODULAR ASSEMBLIES FOR PROMOTING DEVELOPMENT IN DEVELOPING HUMANS VIA AUDITORY STIMULATION

(75) Inventor: Oren Oz, Modiin (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: NUVO GROUP LTD., Modiin (IL)

(21) Appl. No.: 12/811,752

(22) PCT Filed: Jan. 4, 2009
(86) PCT No.: PCT/IL09/00011

§ 371 Date: Aug. 18, 2010

Related U.S. Application Data
(60) Provisional application No. 61/018,678, filed on Jan. 3, 2008.

(51) Int. Cl. G09B 5/04

(52) U.S. Cl. 434/319

(57) ABSTRACT

An evolutionary system and method to promote the development of developing humans via auditory stimulation. The system addresses the need of growing developing humans for constantly changing auditory stimulation environments. The disclosed system comprises an auditory stimulation assembly and a corresponding set of various parental environments such as a maternity belt, a crib, a toy or a stroller. The auditory stimulation assembly may be enveloped within each and every parental environment creating a different auditory stimulating parental environment. For each and every parental environment, the auditory stimulation assembly may be configured, either automatically or manually, to produce audio signals with the characteristics most suitable to the specific parental environments, which specifically designed for the unique stage of the developing human.

### PRIORITY INFORMATION

This patent application is a continuation-in-part application that claims priority from pending international patent application no. PCT/IL2009/000011 filed in the PCT Division of the Israeli Patent Office on 4 Jan. 2009 by Applicant Nuvo Group, Ltd. The international patent application lists the U.S. as a designated state.

### TECHNICAL FIELD

The present invention relates generally to parental environment accessories, and more particularly, to a system and method to promote development in developing humans via auditory stimulation.

### BACKGROUND OF THE RELATED ART

Prior to setting forth the background of the related art, it may be helpful to set forth the definition of the term “developing human” that will be used hereinafter. The term “developing human” as used herein in this application, is defined as including fetuses, infants and children at various ages.

Auditory stimulation has been considered for a while as an effective means for promoting development of fetuses and infants at various ages. Babies exposed to prenatal and postnatal music exhibit superior gross and fine motor activities, linguistic development, some aspects of body-sensory coordination and enhancements of cognitive behavior.

Naturally, in order to achieve optimal effect, the auditory stimulation needs to correlate with the specific requirements and the mental stage of the developing human. Usually, the characteristics of the audio signal are adjusted to match the infant's requirements in accordance with his or her age and development stage. The characteristics of the audio signal may comprise the pitch and the amplitude, as well as other tonal and frequency qualities.

### SUMMARY OF THE PRESENT INVENTION

One aspect of the present invention is directed to an auditory stimulating assembly comprising at least one audio source; an amplifier; and at least one speaker, wherein the at least one audio source is connected via the amplifier to the at least one speaker; wherein the auditory stimulating assembly is arranged to produce audio content relating to a developing human in various mental stages, the audio content varying with a time parameter and varying with at least two of the following three parameters in which the developing human is located: light, humidity, temperature, and an adaptor allowing the auditory stimulating assembly to be enveloped within or attached to at least three parental environments including out the following four parental environments: a maternal carrier, a toy, a crib, a car seat and a stroller, the auditory stimulating assembly having auditory stimulating characteristics that correspond to a parental environment that the auditory stimulating assembly is enveloped within or attached to.

A further aspect of the present invention is an auditory stimulating assembly comprising at least one audio source; an amplifier; and at least one speaker, sensors, wherein the at least one audio source is connected via the amplifier to the at least one speaker; wherein the auditory stimulating assembly is arranged to produce audio content relating to developing humans in various mental stages, the sensors causing the audio content to vary with three of the following five parameters: movement, pressure, light, humidity, temperature, and wherein the auditory stimulating assembly is capable of being enveloped within or attached to a toy, a crib and a stroller, the auditory stimulating assembly having auditory stimulating characteristics that correspond to the parental environment that the auditory stimulating assembly is enveloped within or attached to.

A still further aspect of the present invention is a system for promoting development in developing humans via auditory stimulation, said system comprising an auditory stimulating assembly comprising at least one audio source; an amplifier; and at least one speaker, and a set of corresponding parental environments; wherein the at least one audio source is connected via the amplifier to the at least one speaker; wherein the auditory stimulating assembly is arranged to produce audio content relating to developing humans in various mental stages; and wherein the auditory stimulating assembly is configured to be enveloped within each parental environment of the set of corresponding parental environments, in a manner yielding a different parental environment with auditory stimulating characteristics corresponding the parental environment.

A yet still further aspect of the present invention is directed to a method to promote development in developing humans via auditory stimulation, said method comprising providing an auditory stimulation assembly configured to be enveloped within a plurality of corresponding different parental environments; and providing a plurality of corresponding parental environments, each corresponding with a different stage and needs of a developing human.

A still further aspect of the present invention is an auditory stimulating assembly capable of being either enveloped within or attached to each of a plurality of parental environments, the parental environment including at least three of a group of parental environments consisting of a maternal carrier, a toy, a crib and a stroller, the auditory stimulating assembly configured to adapt an audio content from an audio source and speaker to produce audio content relating to developing humans in various mental stages, the audio content varying with at least two of the following four parameters of an environment in which the developing human is located: light, humidity, temperature, motion.

Embodiments of the present invention provide an evolutionary system and method to promote the mental development of developing humans via auditory stimulation. The invention addresses the need of the growing fetuses and infants for a constantly changing auditory stimulation environment. Specifically, the present invention comprises an auditory stimulation assembly and a corresponding set of various parental environments such as a maternity belt, a crib, a toy or a stroller. The auditory stimulation assembly may be enveloped within each and every parental environment creating a different auditory stimulating parental environment. For each and every parental environment, the auditory stimulation assembly may be configured, either automatically or manually, to produce audio signals with the characteristics most suitable to the specific parental environments and the mental stage of the developing human, the specific parental environment is designed for.

These and other features, aspects and advantages of the present invention will become better understood with reference to the following drawings, descriptions and claims.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein:

FIG. 1 is a high level schematic diagram depicting the elements of the system and the according to one embodiment of the present invention;

FIG. 2A and FIG. 2B show perspective views of a maternal carrier with an without incorporation of an auditory stimulating assembly, in accordance with one embodiment of the present invention;

FIG. 3 is another exemplary implementation of the present invention;

FIG. 4 is another exemplary implementation of the present invention;

FIG. 5 is yet another exemplary implementation of the present invention;

FIG. 6 shows a high level flowchart illustrating a method of promoting development in infants via auditory stimulation, according to some embodiments of the present invention;

FIG. 7 is a side view of a universal adaptor, in accordance with one embodiment of the present invention;

FIG. 8 is a perspective view of a doll connected by a universal adaptor to a crib, in accordance with one embodiment of the present invention;

FIG. 9 is a rear view of a doll and a modular base, in accordance with one embodiment of the present invention;

FIG. 10 is a bottom view of the doll of FIG. 9 showing a female element of the modular base, in accordance with one embodiment of the present invention;

FIG. 11 is a side view of a release mechanism in the base, in accordance with one embodiment of the present invention;

FIG. 12A is a top view of a male attachment element, in accordance with one embodiment of the present invention;

FIG. 12B is a side view of the male attachment element, in accordance with one embodiment of the present invention;

FIG. 12C is a front view of the male attachment element, in accordance with one embodiment of the present invention;

FIG. 13 is a sectional view taken along line 13-13 of FIG. 9;

FIG. 14A is a front view of an auditory stimulating assembly integrated into a toy boat in accordance with one embodiment of the present invention;

FIG. 14B is a rear view of FIG. 14A;

FIG. 15A is a rear view of an auditory stimulating assembly integrated into a toy car in accordance with one embodiment of the present invention;

FIG. 15B is a front view of FIG. 15A; and

FIG. 16 is a schematic diagram describing the elements of the system, in accordance with one embodiment of the present invention

The drawings together with the description make apparent to those skilled in the art how the invention may be embodied in practice.

Further, where considered appropriate, reference numerals may be repeated among the figures to indicate corresponding or analogous elements.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Embodiments of the present invention disclose a system and method to promote mental development in developing humans (e.g. fetuses, infants and children) via auditory stimulation, wherein the system may comprise an auditory stimulation assembly that is configured to be enveloped within a variety of different parental environments, each attributed to different stages and needs of the developing human. In addition, the characteristics of the audio signal may be configured such that they may correlate with the specific mental stage and needs of the developing human as the parental environment changes. The parent using the auditory stimulating assembly use the audio player to select actual audio content outputted by the assembly and the assembly may be programmed through the controller to convert various inputted parameters (light, humidity, sound, temperature, pressure, motion, time, etc.) sensed by sensors to configure the audio content of the assembly and the functioning of the assembly to tailor this audio content to the parental environment.

In contrast to auditory stimulating assemblies of the prior art, the assembly, system and/or method of the present invention may be designed for multiple parental environmental. In further contrast to the prior art audio stimulating assemblies for children, the present invention may be designed to adapt its audio content based on the mental stage of the development fetus or child and may adapt its audio content to various parameters, including, light, time, humidity, temperature, speed that may exist in the environment of the fetus or child. In further contrast to the prior art, the present invention may utilize a universal modular adaptor allowing it to be easily moved from one parental environment to another parental environment. In still further contrast to the prior art, the audio content of the assembly, method and system of the present invention may be correlated with the position of the shade of a stroller.

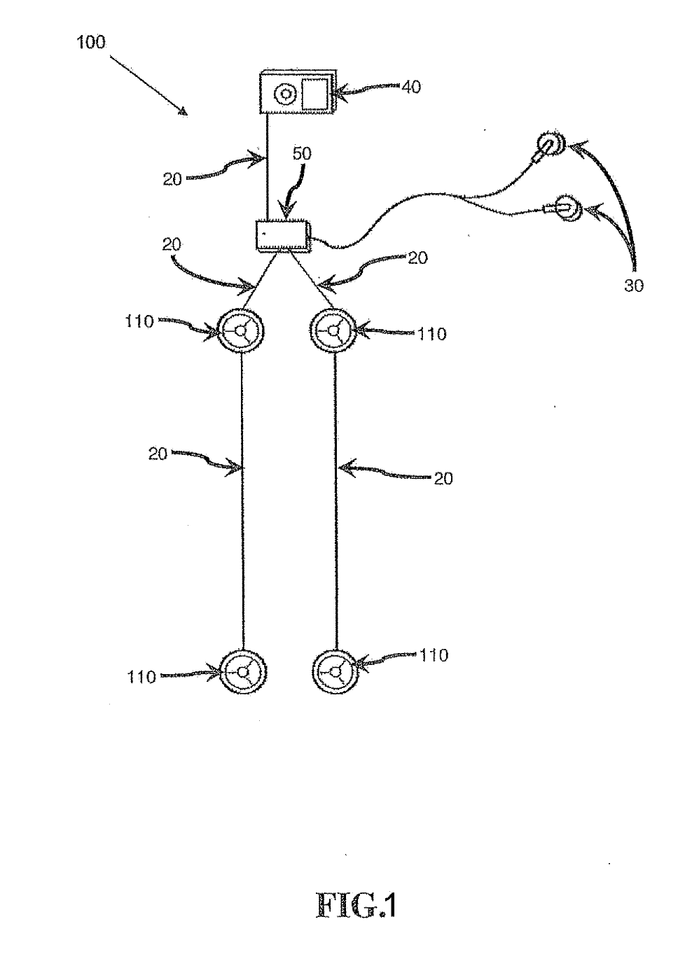

FIG. 1 is a high level schematic diagram depicting the elements of the disclosed auditory stimulation assembly according to some embodiments of the present invention. FIG. 1 shows an assembly comprising an audio reproduction system 100 that may comprise an array of speakers 110 (an array may comprise a single speaker as well), an audio device 40, and an amplifier 50 that may be configured to limiting and tailoring the audio gain and/or tonal ranges and/or frequencies of the emitted sounds to within suitable and healthy ranges for an in utero fetus as well as post natal developmental stages.

Assembly 100 may include a controller 50 that may comprise an amplifier 50 and which may include a CPU (not shown) to process sensor inputs to affect audio output.

Speakers 110 may be connected in parallel or in series or in a combination of both to amplifier 50. Speakers 110 may be eliminated from the assembly or additional speakers may be added to the assembly and connected in turn to amplifier 50, creating groups of speakers. For example, each speaker 110 within a group may be connected in parallel and the groups comprising arrays of speakers 110 may be connected in series or all of speakers 110 may be connected in series.

According to some other embodiments, speakers 110 are connected to amplifier 50 via wires 20 or alternatively, amplifier 50 and speakers 110 may be provided with wireless circuitry and the transference of the corresponding audio signal is performed via wireless connection.

According to some other embodiments, amplifier 50, apart from amplifying the audio signal may be further configured to adjust the characteristics of the audio signal. Specifically, amplifier 50 may be configured to change the pitch and the amplitude of the signal so that the audio signal intensity is adapted to the age of the developing human.

According to some embodiments of the invention, the tonal and frequency qualities of the audio signal may also be adjusted. The amplitude of certain frequencies may be reduced or omitted altogether, in order to conform to the particular needs of the infant or fetus at certain mental stages.

According to some embodiments of the invention, amplifier 50 is further arranged to adjust sound parameters. Amplifier 50 may be further configured for adjusting the frequencies and/or tonal qualities, and/or other sound ranges between those that are suitable for prenatal use and those that are suitable postnatal use.

Audio source 40, according to embodiments of the present invention, may be a relay unit arranged for receiving audio streaming/audio files from a third party. It may also be a storage device arranged to store audio files that may be changed periodically. Further, audio source 40 may comprises any type of sound source or audio playback component, such as, inter alia, a tuner, a cassette player, a compact disc (CD) player, an MP3/4 player and the like. According to some embodiments, the auditory stimulation assembly 100 may be equipped with more than one audio source 40 or may be in communication with several third party devices that may transmit audio files to audio source 40 acting as a relay. As shown in FIG. 1, audio source 40, which may be an audio player, may be connected to amplifier 50. In other embodiments not shown in the drawings, audio source 40 may be located inside amplifier 50.

Optionally, the auditory stimulation assembly 100 may further comprise at least one sound reproduction device, such as, inter alia, a pair of earphones 30, a headset, a pair of ear buds, or a loudspeaker, to enable at least one user to listen to the sounds being played to the developing human.

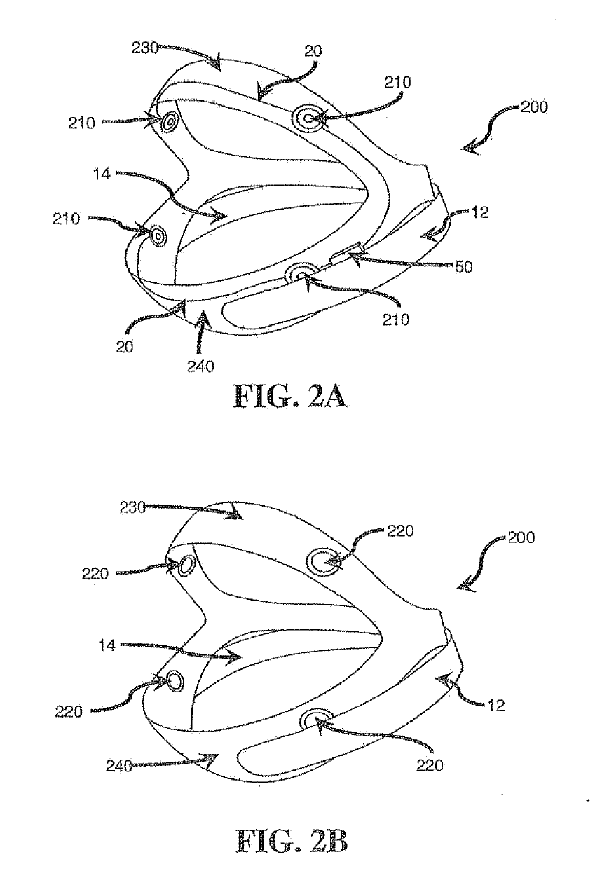

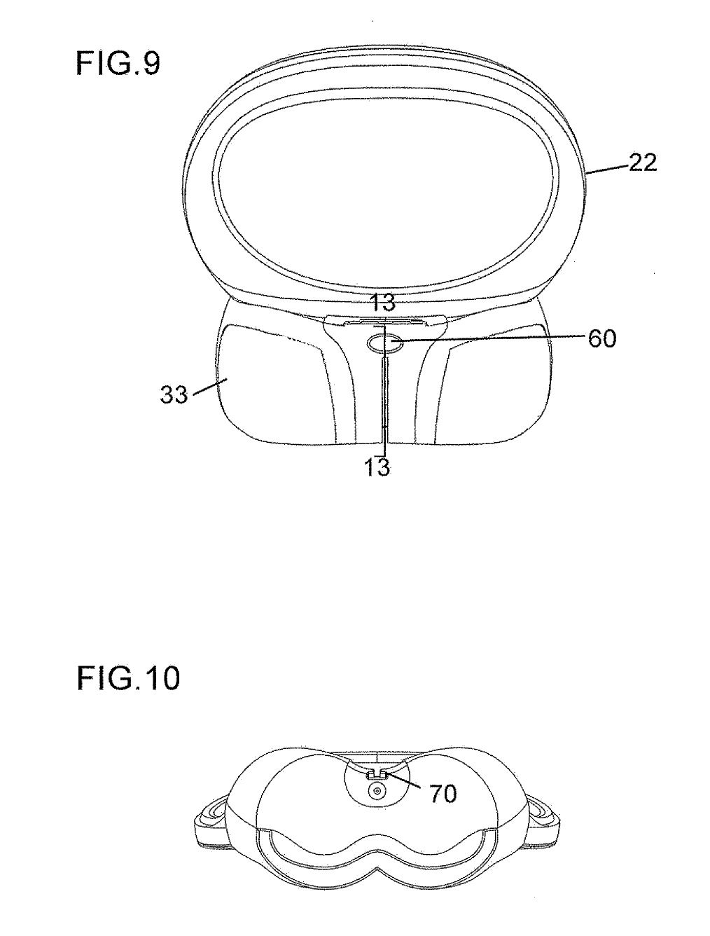

The elements of assembly 100 may fit within a casing or housing. One example of such a casing or housing may be a doll 22. The rear view of an example of such a doll is shown in FIG. 9. Instead of a doll 22, the casing may be any of the casings shown in FIGS. 2-5 such as a maternity belt, a toy, a toy mobile or a stroller shade or any other parental environment. According to some embodiments, each and every element of the auditory stimulation assembly 100 (speakers 110, amplifier 50, audio source 40) may be configured to fit into a variety of parental environments. These environments correspond to different mental stages as well as various needs of the developing human. For example, a parental environment may be a maternity belt, a crib, a mobile, a stroller, a car seat, a toy including but not limited to a soft toy, a toy mobile, a play mat and the like.

According to some embodiments of the invention, wiring 20 is embedded within the parental environments. Merely attaching the elements of the auditory stimulating assembly 100 (speakers 110, amplifier 50, audio source 40) in their corresponding places connects the elements electrically. According to some embodiments, each parental environment is further provided with configuration module set to allow unique audio characteristics for every parental environment. These configuration modules are setting the audio signal such that it matches the mental stage and the needs of the developing human that the specific parental environment is designed for.

According to some embodiments of the invention, two different parental envelopes are provided. The first envelope is designed to fit to the pre-natal stage whereas the second envelope is designed to fit to the post-natal stage. Thus, each of the envelopes may be used with products corresponding with either the pre-natal or the post-natal stages.

The present invention thus provides both modular and versatile assemblies that may be configured ad hoc in accordance with the developmental requirements of the child.

FIG. 2A and FIG. 2B show a maternal carrier 200 comprising an upper arm 230 and a lower arm 240 flexibly conjoined at their ends and adapted to fit around the abdomen of a pregnant woman, which fits into the space 14. Maternal carrier 200 may be adjustable and constructed of materials providing comfortable attachment and carrying. The arrangement of upper arm 230 relative to lower arm 240 enables carrier 200 to accommodate the continuously changing shape of the abdomen of a pregnant woman. Maternal carrier 200 may comprise an attachment means 12 arranged to allow comfortable attachment of maternal carrier 200 to the abdomen. Attachment means 12 may comprise e.g. a Velcro strap, a stretchable piece of cloth, a belt, etc. Maternal carrier 200 may further comprise openings 220 allowing the attachment of speakers 210 onto maternal carrier 200 and in proximity to the abdomen. The auditory stimulation assembly 100 may be integrated into a maternal carrier 200, e.g. speakers 210 may be arranged to fit openings in upper arm 230 and/or lower arm 240 such that the in utero fetus is essentially surrounded by the sounds emitted by speakers 210. As a result, regardless of his position, the in utero fetus can always hear the played back sounds effectively. Attachment means 12 may be further arranged to protect, fixate and conceal elements of the auditory stimulation assembly, such as speakers 210, amplifier 50 and audio source 40. Maternal carrier 200 is considered an example for a parental environment housing the auditory stimulation assembly 100. The auditory stimulation assembly 100 may be mechanically arranged to be switched into an appropriate audio mode upon insertion into and integration with maternal carrier 200. In this pre-natal application, in some cases, the audio content of an assembly 100 integrated into carrier 200 may vary by manipulation of the audio player and may be unaffected by external parameters such as light, temperature, humidity, etc.

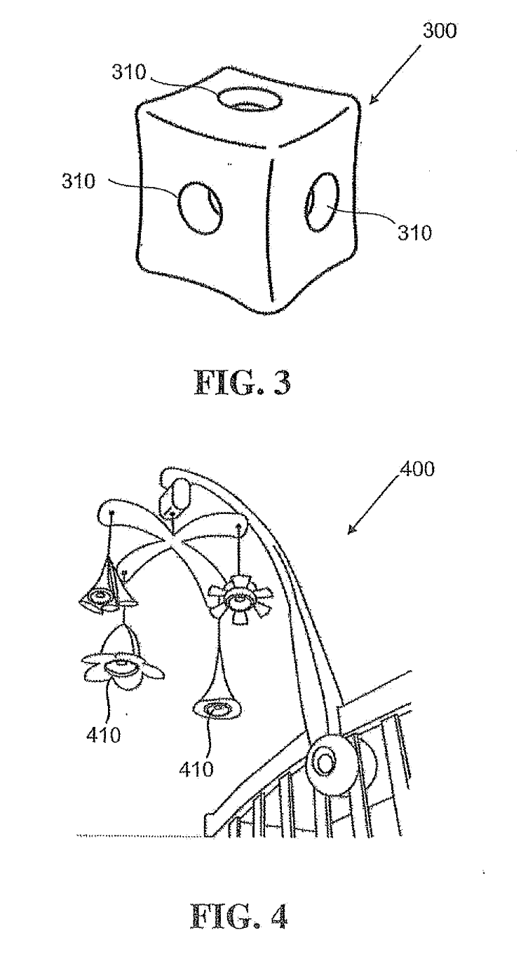

FIG. 3 is another exemplary implementation of the present invention as a soft toy, in this case, a toy box 300. Toy box 300 is fitted with openings 310 configured to accommodate speakers 110 as well as the rest of the elements of the auditory stimulation assembly 100 such as amplifier 50 and audio source 40. Upon playing with toy box 300 audio may be played to enhance the infant's development, e.g. the infant's cognitive development. Toy box 300 is considered an example for a parental environment housing the auditory stimulation assembly 100. The auditory stimulation assembly 100 may be mechanically arranged to be switched into an appropriate audio mode upon insertion to and integration with toy box 300. Furthermore, the audio content played by the auditory stimulation assembly 100 may relate to the state of toy box 300 and generate e.g. different sounds upon throwing, hitting or chewing toy box 300. Toy box 300 may be soft or hard, and the auditory stimulation assembly may be accommodated to the type and material of toy box 300 both mechanically and in respect to its audio content and playing modes.

FIG. 4 is another exemplary implementation of the present invention as a toy mobile 400. Toy mobile 400 may be fitted with openings 410 configured to accommodate speakers 110. Thus, while operating toy mobile 400, it is enhanced by sounds adjusted to the specific operation of toy mobile 400. Toy mobile 400 is considered an example for a parental environment housing the auditory stimulation assembly 100. The auditory stimulation assembly 100 may be mechanically arranged to be switched into an appropriate audio mode upon insertion to and integration with toy mobile 400. Furthermore, the audio content played by the auditory stimulation assembly may relate to the state of toy mobile 400 and generate e.g. different sounds upon different movements of toy mobile 400. The auditory stimulation assembly 100 may be connected to an audio producing apparatus of a standard toy mobile and interrelate its content therewith. The auditory stimulation assembly may comprise sensors 99 (see FIG. 16) allowing it to adapt the audio content to different environmental parameters such as temperature, light, time, humidity and so forth.

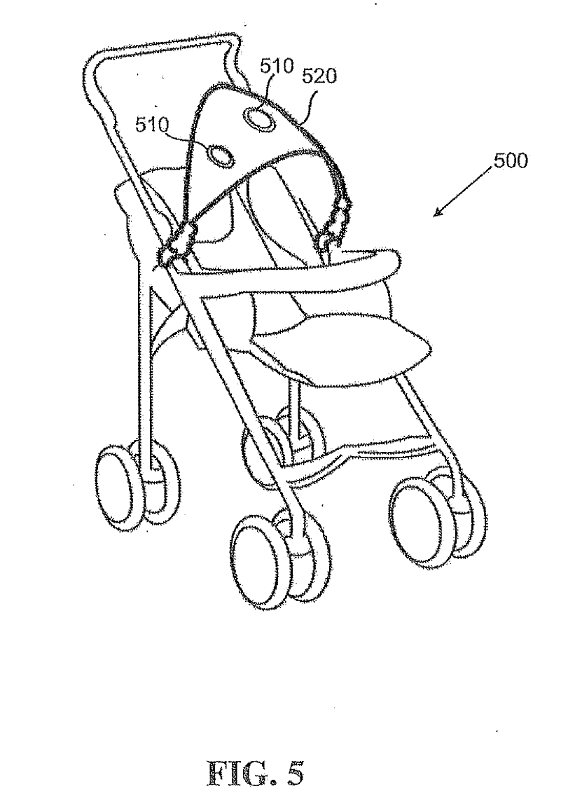

FIG. 5 is yet another exemplary implementation of the present invention as a shade for a stroller 500. Stroller 500 may be a standard stroller, wherein the shade is configured to be attached to the stroller's side thus providing shade. Shade 520 may be fitted with openings 510 to accommodate speakers 110 and may operate in a similar way to toy mobile 400 and toy box 300. Stroller 500 is considered an example for a parental environment housing the auditory stimulation assembly. The auditory stimulation assembly may be mechanically arranged to be switched into an appropriate audio mode upon insertion to and integration with stroller 500.

Furthermore, the audio content played by the auditory stimulation assembly 100 may relate to the state of stroller 500 and may for example generate different sounds upon different movements of stroller 500. The audio content played by the auditory stimulation assembly 100 may relate to the state of shade 520 and may for example generate different sounds upon different movements and positions of shade 520. For example, when the shade is moved into a protective position to protect against rain falling on a child seated in stroller 500, especially a protective position that utilizes a rainproof barrier, that movement may trigger audio content that refers to rain. This can be a song referring to rain or it can be other content such as dialog prompts concerning rain. Furthermore, if in addition, the temperature sensor also senses a temperature below the freezing point of water or rain, the audio content may refer to snow.

As seen in FIG. 16, the auditory stimulation assembly 100 may include a controller 50 that may comprise a CPU and may include sensors 99 allowing controller 50 to adapt the audio content based on input of different environmental parameters such as speed, temperature, light, time, humidity, movement, sound and so forth. In some embodiments, controller 50 may also include the audio player 40 physically inside controller 50, in which case controller 50 may include memory for the audio player, memory for the recorder, memory for the player functions. The environmental parameters include two kinds of parameters: those triggered or affected by actions of the child or fetus and those unrelated to the actions of the child or fetus. The second category of environmental parameters may in general be triggered by environmental factors rather than human action.

The sensors 99 may include light sensors, pressure sensors, temperature sensors, motion sensors, humidity sensors and time sensors, i.e. a clock. Motion sensors 99 may include sensors of speed, sensors of gyrating motion, sensors of other movement such as shaking. The input from these sensors 99 may be translated to control various functions of the controller 50. For example, the temperature sensor may affect the volume of the music from the speaker. If the temperature rises past a certain threshold temperature the volume of the audio content may be reduced by the controller 50 automatically. In some case, the volume may be reduced in proportion to the increase in temperature or in proportion to the amount that the temperature exceeds the threshold.

The motion sensor may be used in several ways to adapt the audio content. In one example, one or more motion sensors may be affected by parameters affected by the child. For example shaking by the child of an auditory stimulation assembly or of a doll or other container that houses the sensor may result in changing the song choice or changing the volume of an existing song choice being played at the time of the shaking. In addition, if the motion sensor senses that the child has moved a particular part of the doll, the controller can change the song or adjust the volume. The motion sensor may also sense motion caused by other persons or caused by factors unrelated to the child.

A light sensor may sense reduced light or darkness and may shut the device off. The light sensor may direct that an arm of the doll wave to the child when a certain amount of light appears in the room or environment. In addition, the light sensor in the controller may control mechanical components in the casings of the doll. For example, when the sun comes up and the room becomes lighter, the light sensor may turn on the device. A time sensor may enable automatic shut off of the auditory stimulation assembly or of select functional components of the auditory stimulation assembly at a set time at night or at a range of times.

The mechanical components of a doll 22 (see, e.g. FIG. 9) or other container that houses or integrates the auditory stimulation assembly 100 may also operate as functional sensors. For example, moving the eye of the toy, for example in a circular motion, can effectuate a proportionate movement in the volume level of the audio content. Shaking the doll's hand (an action that would presumably be taken by the developing human, i.e. the child) can effectuate a change in songs. In addition, programmed features such as taping the child may also be programmed into the controller and accordingly may be controlled by any of the above-mentioned sensors. For example, when light is detected in the room or environment, a taping mechanism may be activated that begins recording noises or sounds made by the child. A timer or a change detected by another sensor may shut off the tape.

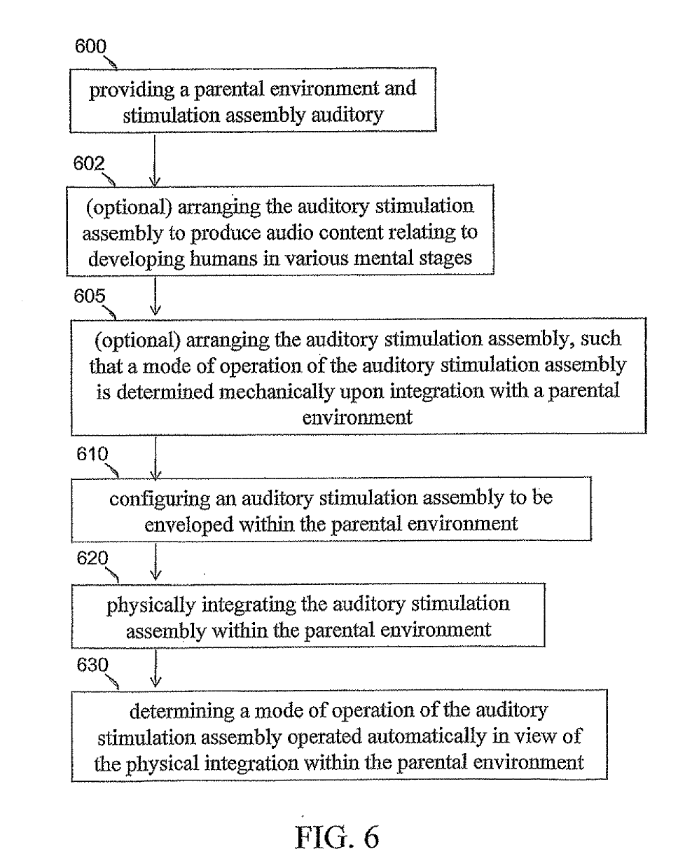

FIG. 6 is a high level flowchart illustrating a method of promoting development in infants via auditory stimulation, according to some embodiments of the invention. The method comprises the stages: providing a parental environment (stage 600), such as maternal carrier 200, toy mobile 400, toy box 300 or stroller 500; configuring an auditory stimulation assembly to be enveloped within the parental environment (stage 610), e.g. adjusting electro-mechanical elements such as wiring as well as adjusting audio parameters; physically integrating the auditory stimulation assembly 100 within the parental environment (stage 620), e.g. in relation to predefined opening, straps and locators in the parental environment; and determining a mode of operation of the auditory stimulation assembly operated mechanically in view of each potential physical integration of the parental environments (stage 630). For example, the auditory stimulation assembly may be configured to be switched while physically integrating it within the parental environment (stage 620).

In general, the term audio content may also include the volume of the audio. Assembly 100 may be programmed through the controller 50 to convert various inputted parameters (light, humidity, sound, temperature, pressure, motion, time, etc.) sensed by sensors to configure the audio content of the assembly and the functioning of the assembly (for example whether audio player 40 is on or off) to tailor this audio content to the parental environment. The parent may select particular audio content to be played by the audio player 40. For example, the parent may select a particular bedtime song but the assembly 100 may be programmed to play a bedtime song when light sensors 99 indicate that the level of light in the room has decreased to a certain point.

The present invention can also be characterized as an auditory stimulating assembly 100 capable of being either enveloped within or attached to each of a plurality of parental environments, the parental environment including at least three of a group of parental environments consisting of a maternal carrier, a toy, a crib and a stroller. The auditory stimulating assembly 100 may be configured to adapt an audio content from an audio source and speaker to produce audio content relating to developing humans in various mental stages, the audio content varying with at least two of the following four parameters of an environment in which the developing human is located: light, humidity, temperature, motion.

According to some embodiments of the invention, the auditory stimulation assembly 100 may be arranged (stage 605) such that a mode of operation of the auditory stimulation assembly 100 is determined mechanically upon integration with a parental environment. The mode of operation of the auditory stimulation assembly 100 may be related to the parental environment and its characteristics. For example, the audio content played by the auditory stimulation assembly may relate to the type or state of the parental environment, such as having different characteristics for different parental environments (e.g. different music for parental environments relating to developing humans at different ages), for different states of the parental environment (e.g. moving, being shaken, resting) or for different environmental parameters relating to the parental environment (e.g. temperature, light).

According to some embodiments of the invention, the method further comprises arranging the auditory stimulation assembly to produce audio content relating to developing humans in various mental stages (stage 602).

Suggested steps of a method to promote mental development of developing humans via auditory stimulation are as follows: Providing the auditory stimulation assembly to enable parents to later purchase only the required corresponding parental environments on an ad hoc basis. Advantageously, this arrangement significantly lowers the cost of adjusting an auditory stimulating parental environment for the developing human. Since the main cost of auditory stimulating parental environments concentrates on the auditory stimulating assembly, making the auditory stimulating assembly versatile and reusable within various parental environments reduces the expenses. Thus, more auditory stimulating parental environments may be experienced by the developing human for the same price.

As shown in FIG. 10 through FIG. 13, the auditory stimulating assembly 100 of the present invention may also include a modular adapting mechanism that may allow an auditory stimulation assembly to be attachable to multiple parental environments. The modular adapting mechanism may be comprised of a male attachment member 42 (FIGS. 12A, 12B, 12C) together with a female attachment member 70 (FIG. 10). A top view of male attachment member 42 may be seen from FIG. 12A. FIG. 12B shows a side view of male attachment member 42.

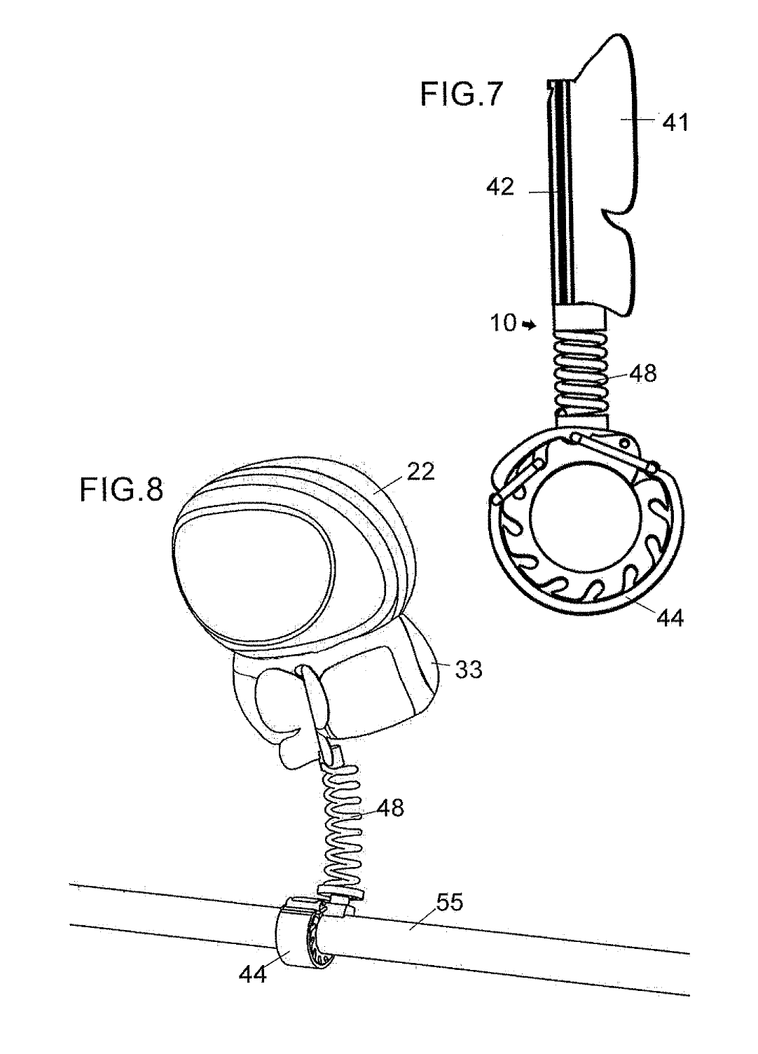

An expanded version of the modular adaptor is shown in FIG. 7. In cases where assembly 100 is housed within a doll 22 such as is shown in FIG. 8, the modular expanded adaptor 10 of FIG. 7 may be used to attach the auditory stimulation assembly 100 of the present invention to different parental environments especially those containing a circular element such as a bar of a crib, stroller or toy. Expanded adaptor 10 may include a spring 48 that may connect an annular portion 44 to a male attachment element 42. Spring 48 may be rigid enough to support doll 22 housing the auditory stimulation assembly within it. FIG. 8 shows an annular portion 44 that may removably connect to a bar 55 that may form part of a parental environment such as a crib 55 or stroller 500 or toy. As shown in FIG. 7 and FIG. 8, expanded adaptor 10 may also include a butterfly-shaped design element integrated to the male attachment element 42.

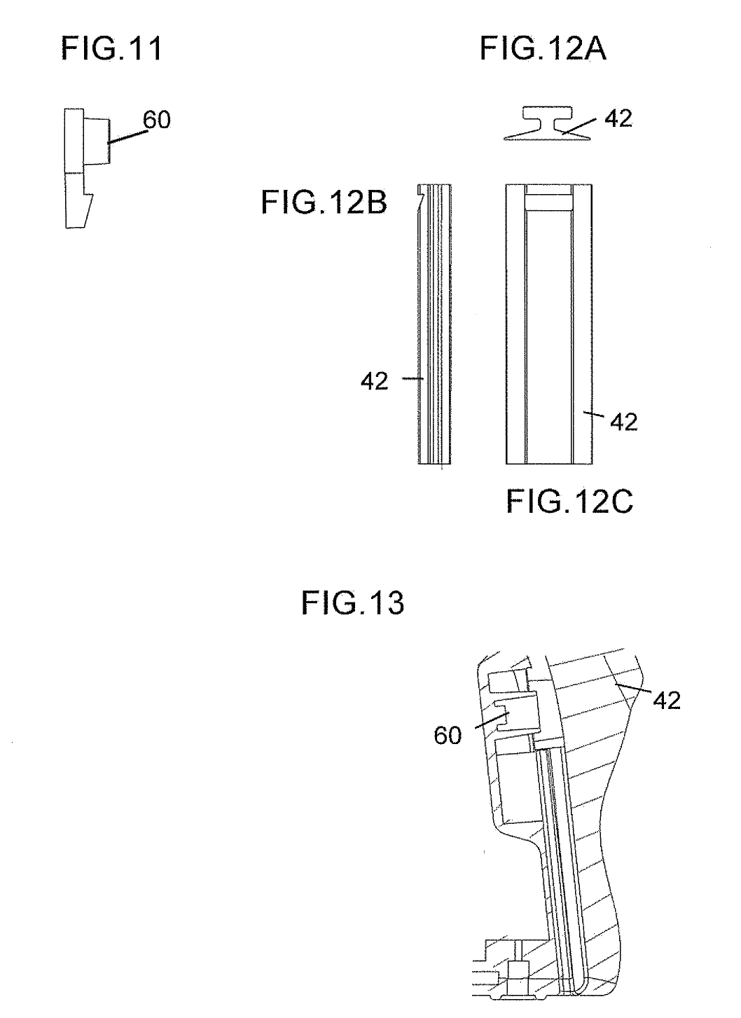

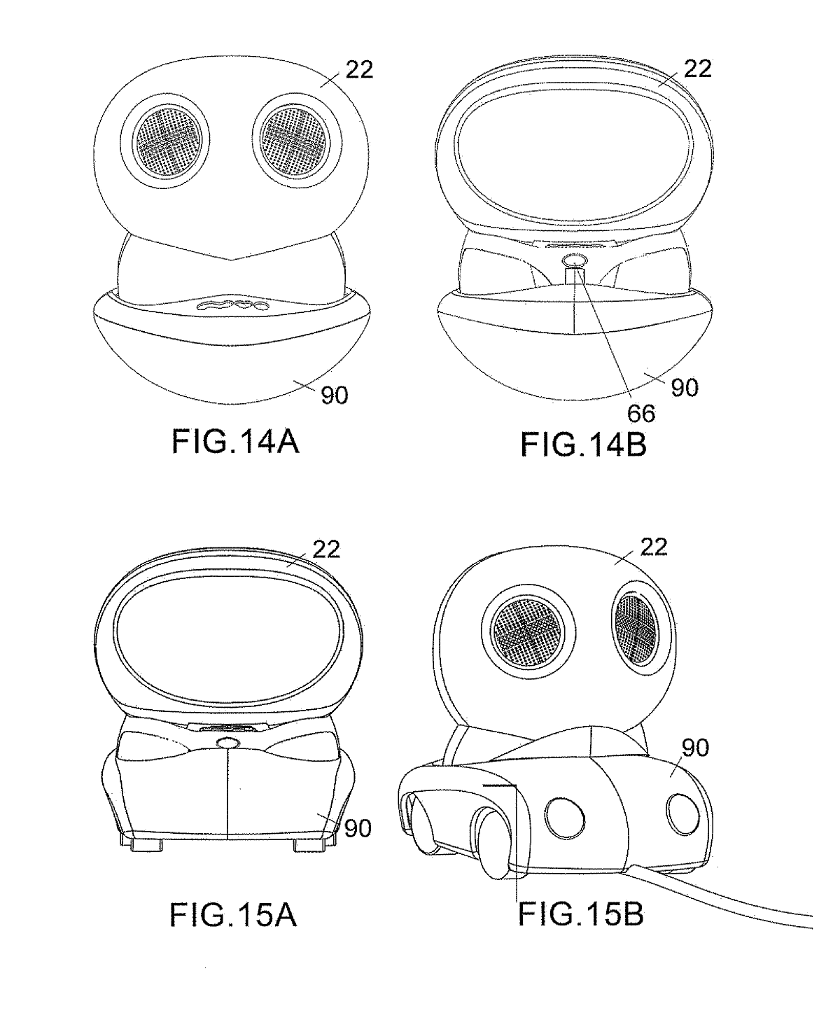

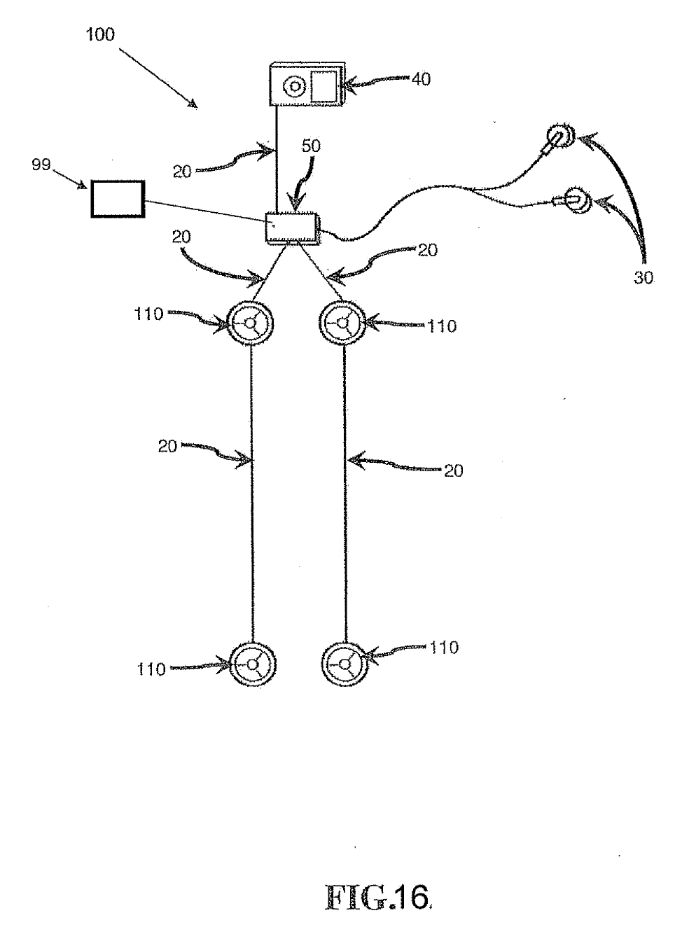

Male attachment element 42 (see FIGS. 12A-11C and FIG. 13) may be insertable into a female attachment element 70 (see FIG. 10). Female attachment element 70 (FIG. 10) may be defined within a modular base 33 of doll 22 (FIG. 8 and FIG. 9). It is contemplated by the present invention that in certain embodiments male attachment member 42 shown in FIGS. 12A, 12B, 12C may constitute on its own a universal adaptor or universal connector that may be used to connect and integrate the auditory stimulating assembly 100 of the present invention to different parental environments shown in FIGS. 8, 14A, 14B, 15A, 15B or to other parental environments that utilize doll 22 since male attachment member 42 fits into a female element 70 defined within doll 22. In other embodiments, male and female attachment elements 42, 70 (FIG. 10) may together constitute a universal adaptor that may be used to connect assembly 100 to doll 22 and to parental environments utilizing doll 22 such as are shown in FIGS. 8, 14A, 14B, 15A, 15B. In still other embodiments, modular base 33 of doll 22 plus male and female attachment elements 42, 70 may constitute a universal adaptor that may allow assembly 100 to be integrated into a variety of parental environments. As seen in FIG. 8 and in FIG. 9, modular base 33 may attach to a doll 22 or to a toy or to other child related or fetus related object/environment. For example, FIGS. 14A and 14B show the front and rear views, respectively, of a different embodiment of modular base 90 in the form of a toy attached to doll 22. In this case, base 90 is such that the toy, when pushed to the side reverts to its standing position. FIGS. 15A and 15B show the rear and front views, respectively, of a further embodiment of modular base 90 in the form of a toy car integrated with the auditory stimulation assembly. As shown in FIGS. 14A and 15B, doll 22 may have eyes formed by the speakers or a facade of the speakers of the auditory stimulation assembly housed within it.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing selected steps or tasks manually, automatically or by a combination of manually and automatically.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. An auditory stimulating assembly comprising:
at least one audio source;
an amplifier; and
at least one speaker,
wherein the at least one audio source is connected via the amplifier to the at least one speaker;
wherein the auditory stimulating assembly is arranged to produce audio content relating to a developing human in various mental stages, the audio content varying with a time parameter and varying with at least two of the following three parameters in which the developing human is located: light, humidity, temperature, movement, pressure and
an adaptor, allowing the auditory stimulating assembly to be enveloped within or attached to at least three parental environments including out the following parental environments: a maternal carrier, a toy, a crib, a car seat and a stroller, the auditory stimulating assembly having auditory stimulating characteristics that correspond to a parental environment that the auditory stimulating assembly is enveloped within or attached to.

2. The auditory stimulating assembly of claim 1, wherein the auditory stimulating assembly is capable of being enveloped within or attached to a maternal carrier, a toy, a crib and a stroller.

3. The auditory stimulating assembly of claim 1, wherein the audio content in varied in relation to a position of a shade of the stroller.

4. The auditory stimulating assembly of claim 3, wherein the audio content relates to rain when the shade is positioned to protect a child sitting in the stroller against rain.

5. The auditory stimulating assembly of claim 3, wherein different movements and different positions of the shade generate different audio content.

6. The auditory stimulating assembly of claim 1, wherein a mode of operation of the auditory stimulating assembly is set upon mechanically attaching a universal adaptor to a particular parental environment.

7. The auditory stimulating assembly of claim 1, wherein the amplifier is further arranged to adjust sound parameters of the amplifier comprising at least one of: pitch, amplitude, frequencies, timbre.

8. The auditory stimulating assembly of claim 1, wherein the adaptor is connected to an annular portion to connect the auditory stimulation assembly to a toy, to a crib and to a stroller.

9. The auditory stimulating assembly of claim 1, further including a spring connecting the adaptor to the annular portion.

10. An auditory stimulating assembly comprising:
at least one audio source;
an amplifier; and
at least one speaker,
sensors,
wherein the at least one audio source is connected via the amplifier to the at least one speaker;
wherein the auditory stimulating assembly is arranged to produce audio content relating to developing humans in various mental stages, the sensors causing the audio content to vary with three of the following five parameters: movement, pressure, light, humidity, temperature, and
wherein the auditory stimulating assembly is capable of being enveloped within or attached to a toy, a crib and a stroller, the auditory stimulating assembly having auditory stimulating characteristics that correspond to the parental environment that the auditory stimulating assembly is enveloped within or attached to.

11. The auditory stimulating assembly of claim 10, wherein the audio content varies with a time parameter.

12. The auditory stimulating assembly of claim 10, wherein the developing human comprises at least one of: a fetus, an infant.

13. A system for promoting development in developing humans via auditory stimulation, said system comprising:
an auditory stimulating assembly comprising:
at least one audio source;
an amplifier; and
at least one speaker, and
a set of corresponding parental environments;
wherein the at least one audio source is connected via the amplifier to the at least one speaker;
wherein the auditory stimulating assembly is arranged to produce audio content relating to developing humans in various mental stages; and
wherein the auditory stimulating assembly is configured to be enveloped within each parental environment of the set of corresponding parental environments, in a manner yielding a different parental environment with auditory stimulating characteristics corresponding the parental environment.

14. The system of claim 13, wherein the set of corresponding parental environments comprises at least one of a maternal carrier, a toy, a crib, a stroller.

15. The system of claim 13, wherein the auditory stimulating assembly further comprises a module for recording and transmitting at least one auditory message to the developing human.

16. The system of claim 13, wherein the auditory stimulating assembly further comprises a plurality of operation modes corresponding to various parental environments and wherein the auditory stimulating assembly is arranged to determine a potential mode of operation mechanically upon physical integration with a parental environment.

17. The system of claim 13, wherein the developing human comprises at least one of: a fetus, an infant.

18. A method to promote development in developing humans via auditory stimulation, said method comprising:
providing an auditory stimulation assembly configured to be enveloped within a plurality of corresponding different parental environments; and
providing a plurality of corresponding parental environments, each corresponding with a different stage and needs of a developing human.

19. The method of claim 18, further comprising configuring the auditory stimulation assembly to be enveloped within the plurality of parental environments.

20. The method of claim 18, further comprising physically integrating the auditory stimulation assembly within at least one of the parental environments.

21. The method of claim 18, further comprising arranging the auditory stimulation assembly such that a mode of operation of the auditory stimulation assembly is determined mechanically upon integration with a parental environment.

22. The method of claim 18, further comprising arranging the auditory stimulation assembly to produce audio content relating to developing humans in various mental stages.

23. The method of claim 18, further comprising adjusting sound parameters of the auditory stimulation assembly comprising at least one of: pitch, amplitude, frequencies, timbre.

24. The method of claim 18, further comprising recording and transmitting at least one auditory message to the developing human.

25. The method of claim 18, wherein the developing human comprises at least one of: a fetus, an infant.

26. An auditory stimulating assembly capable of being either enveloped within or attached to each of a plurality of parental environments, the parental environment including at least three of a group of parental environments consisting of a maternal carrier, a toy, a crib and a stroller, the auditory stimulating assembly configured to adapt an audio content from an audio source and speaker to produce audio content relating to developing humans in various mental stages, the audio content varying with at least two of the following four parameters of an environment in which the developing human is located: light, humidity, temperature, motion.
